(19) United States
(12) Patent Application Publication
(10) Pub. No.: US 2026/0110152 A1
(43) Pub. Date: Apr. 23, 2026

(54) DOUBLE-SIDED DRAIN LINER

(71) Applicant: Agru/America, Inc., Georgetown, SC (US)

(72) Inventor: Anthony Johnson, Conway, SC (US)

(73) Assignee: Agru/America, Inc., Georgetown, SC (US)

(21) Appl. No.: 19/243,468

(22) Filed: Jun. 19, 2025

Related U.S. Application Data
(60) Provisional application No. 63/709,815, filed on Oct. 21, 2024.

(51) Int. Cl. E02D 31/00

(52) U.S. Cl. CPC E02D 31/004

(57) ABSTRACT

A landfill cap for covering a landfill has a gas-venting geotextile facing the landfill. A double-sided drain liner has a flexible fluid impervious barrier sheet with a lower surface facing the gas-venting geotextile and an upper surface opposite the lower surface. Lower truncated projections project from the lower surface of the barrier sheet and have blunt projecting ends supported in nonpenetrating contact with the gas-venting geotextile so that the barrier layer is spaced from the gas-venting geotextile and so that gas venting passages are defined between the lower truncated projections. Upper truncated projections project from the upper surface of the barrier sheet and have blunt projecting ends. A fluid permeable layer is supported in nonpenetrating contact on the blunt projecting ends of the upper truncated projections of the double-sided drain liner so that liquid drainage passages are defined between the upper truncated projections.

### CROSS-REFERENCE TO RELATED APPLICATION

This application claims priority to U.S. Provisional Patent Appl. No. 63/709,815 filed Oct. 21, 2024, the entire disclosure of which is incorporated herein by reference.

### BACKGROUND

### 1. Field of the Invention

The invention relates to a drain liner that can be used as part of a geomembrane assembly that is particularly well suited for use with landfills.

### 2. Description of the Related Art

The disposal of waste material presents challenges to environmental engineers and landfill operators. In particular, waste materials must be stored and/or disposed of in a manner that protects the environment from contamination. In this regard, rain can cause decaying waste material to leach into the ground surface below the landfill, thereby contaminating the soil and aquifers. Wind can cause particles of the waste material to be transported away from the landfill site and deposited at a location that is not protected. Additionally, decaying waste material can produce gaseous materials, such as methane. Methane is considered to have a harmful effect on health and produces annoying odors. Multilayer landfill lining systems are used to prevent or minimize these adverse effects.

Most landfill lining systems include a fluid impervious geomembrane that covers the entire landfill to prevent rain water from penetrating into the landfill in a manner that could transport decaying materials into soil and aquifers below the landfill site. The fluid impervious geomembrane also retains material in the landfill that might otherwise be transported away from the landfill site by wind.

Most landfill sites position geomembranes over the landfill to contain the methane that is produced and to keep the waste material relatively dry so that the methane production rate is relatively low. The upper geomembrane or cap also prevents the deposited waste material from being transported by wind or rain to locations that are not protected adequately by the geomembrane.

At least part of the upper surface of a landfill is likely to be sloped, and the geomembrane that covers the upper surface of the landfill will conform to and follow this sloped upper surface of the waste material. Gravitational forces applied to the geomembrane can cause the geomembrane to slip gravitationally down along the sloped surface, thereby permitting unimpeded emission of methane gas and leaving upper regions of the deposited waste material exposed and subject to being moved by wind or rain to unprotected locations. Movement of the geomembrane also can be caused by movement of the ground due to periodic freezing and thawing, seismic movement of the earth and/or forces generated by nearby equipment, such as transportation vehicles that periodically deliver or remove material from the landfill site. Movement of the geomembrane along the sloped surface of the landfill can be impeded by roughening the lower surface of the geomembrane or by forming sharply pointed projections on the lower surface of the geomembrane. These projections or roughened regions are intended to bite into the upper surface of the waste material or the upper surface of soil that has been deposited at the landfill site. This biting of the sharply pointed projections into the substrate is intended to prevent sliding movement of the geomembrane along the upper surface.

The known fluid impervious geomembrane sheets generally are used as part of a layered system that comprises the fluid impervious sheet in combination with a geocomposite sheet overlain on or placed underneath the fluid impervious sheet. The geocomposite sheet typically comprises a net-like sheet and a porous geotextile bonded to one or both surfaces of the net. This assembly often is overlain with a vegetative cover of about 18 - 24 inches. The net of the geocomposite is intended to accommodate a flow of liquid and/or gas, and the geotextile of the geocomposite sheet provides filtration and protection properties. Rainwater and/or methane gas that penetrates through the woven or nonwoven geotextile of the geocomposite layer and/or through net-like sheet of the geocomposite layer will flow to appropriate collection points. These known systems generally are effective for most of their intended purposes. However, the geocomposite layers of such system are expensive. Furthermore, the geotextile of the geocomposite layer can become clogged over time, thereby causing pooling or unintended flow patterns. These problems can be addressed by using a fluid impervious geomembrane that has studs projecting from the upper surface. The drainage or filter layer will be supported on the projecting ends of the studs, and fluid drainage channels will be defined between the studs. One such structure is shown in U.S. Pat. No. 5,258,217, which issued to a predecessor to the assignee of the subject application. The fluid impervious geomembrane described in U.S. Pat. No. 5,258,217 also has sharply pointed studs projecting down from the lower surface of the sheet. The studs are intended to bite into the soil of the landfill site to prevent shifting of the geomembrane across the upper surface of the landfill.

As noted above, methane gas is a byproduct of the decaying process of many materials that comprise landfills. The methane gas produced by the landfill can be collected and disposed of in a safe and unobjectionable manner. However, the known geomembranes systems do not provide for efficient flow of both liquid (e.g. rainwater) and methane or other gases to respective collection points.

In view of the above, it is an object of the subject invention to provide a sheet material that can accommodate a flow, channeling and collection of rainwater while also accommodating a flow, venting or collection of gases that are a byproduct of the decaying material in the landfill site.

### SUMMARY OF THE INVENTION

A first aspect of the invention relates to a geomembrane that is particularly suitable for covering a landfill site. The geomembrane may be extruded from a fluid impervious resin, such as polyethylene, polypropylene or polyvinyl chloride. In some embodiments, the geomembrane may be used with a composite that may be produced using an elastomeric bitumen-based binder with a geotextile. The geomembrane comprises a fluid impervious barrier layer with opposite upper and lower surfaces. The geomembrane further includes upper and lower truncated projections that project respectively from the upper and lower surfaces of the barrier layer. Each of the upper and lower projections has a flat, blunted or other non-penetrating shape at or near the end of the projection remote from the barrier layer to prevent or limit penetration of the projection into an adjacent surface or layer. In this regard, an adjacent layer may be a woven or non-woven geotextile layer of a multilayer geomembrane or an adjacent layer of soil or compacted clay. This prevention or limiting of the penetration of the projections into an adjacent layer keeps the barrier layer of the double-sided drain liner spaced from the adjacent layer, thereby keeping open channels to accommodate a flow of gas or liquid adjacent the barrier layer.

In some embodiments, the projecting ends of the upper and lower truncated projections may be substantially planar and substantially parallel to the barrier layer of the geomembrane. Thus, each of the upper and lower truncated projections may be a polygonal structure, a truncated cone, a cylinder or a frustum. A frustum-shaped projection may have a conically generated side surface, or plural intersecting generally planar surfaces in the manner of a truncated pyramid or plural intersecting convexly curved surfaces.

The ends of the projections of some embodiments may have a point surrounded at least partly by a flat shoulder that is parallel to the barrier layer. The point of this embodiment may bite into an adjacent layer to prevent sliding of the double-sided drain liner relative to the adjacent layer, while the flat shoulder limits penetration of the projection into the adjacent layer thereby ensuring open passages adjacent the barrier layer to accommodate flows of gas or liquid. Such points may be formed on only some of the projections.

The upper truncated projections may align respectively with the lower truncated projections. However, in other embodiments, the truncated projections on the upper surface of the barrier layer may be offset from the truncated projections on the lower surface of the barrier layer.

The upper truncated projections may not be provided in a one-to-one relationship with the lower truncated projections. Thus, there may be more or fewer truncated projections on the upper surface of the barrier layer than on the lower surface of the barrier layer.

Another aspect of the invention relates to an assembly of sheets of material that form a landfill cap. The multilayer landfill cap comprises the above-described geomembrane that includes a fluid impervious barrier layer and upper and lower truncated projections that project respectively from both the upper and lower surfaces of the barrier layer. The landfill cap assembly of some embodiments has at least one upper layer supported on the truncated ends of the upper truncated projections and at least one lower layer supported on the truncated ends of the lower truncated projections. With this configuration, upper flow channels are defined between the upper truncated projections, and lower flow channels are defined between the lower truncated projections. Each upper flow channel has a height extending from the barrier layer of the geomembrane to the upper layer and each lower flow channel has a height extending from the barrier layer of the geomembrane membrane to the lower layer.

The upper layer of the assembly may comprise a single layer of material or plural layers of material that are supported in adjacent relationship to one another. Similarly, the lower layer of the assembly may comprise a single layer of material or plural layers of material that are supported in adjacent relationship to one another. The upper and lower layers are selected in accordance with particular requirements and specifications for the landfill site. For example, some embodiments will have an upper drainage layer or filter layer supported on or near the ends of the upper truncated projections, and hence spaced from the barrier layer. The upper drainage layer or filter layer may be formed from a woven or nonwoven material. Some embodiments also will have a layer of a vegetative cover soil covering the surface of the upper drainage or filter layer that faces away from the upper truncated projections. The lower layer of the assembly may comprise a woven or nonwoven gas venting geotextile supported on the ends of the lower truncated projections and hence spaced from the barrier layer. Some embodiments also will have a compacted clay substrate that supports the surface of the gas venting geotextile opposite the lower truncated projections. With this configuration, rain or other liquids that fall onto the upper layer will flow through the upper layer and will travel through the channels defined between the upper truncated projections, and thus in the communicating spaces between the barrier layer and the upper layer. Additionally, with this configuration, methane or other gas produced by decaying material of the landfill will flow through the lower layer and will travel through the gas venting channels between the respective lower truncated projections. This escaping methane gas will flow to a collection point. Significantly, rain or other liquids that flow gravitationally downward through the liquid drainage channels between the barrier layer and the upper layer will not impede the flow of methane gas through the gas venting channels between the barrier layer and the lower layer.

The above-described aspects of the invention will become more apparent in the following detailed description and the accompanying drawings.

### BRIEF DESCRIPTION OF THE DRAWINGS

FIG. 1 is a perspective view of a flexible double-sided drain liner in accordance with a first aspect of the invention with the drain liner being bent or deformed into a non-planar shape.

FIG. 2 is a perspective view of the double-sided drain liner of FIG. 1.

FIG. 3 is an enlarged perspective view of the circled area of FIG. 2 identified by the numeral 3.

FIG. 4 is a side elevational view of the double-sided drain liner of FIGS. 1-3.

FIG. 5 is a top plan view of the double-sided drain liner of FIGS. 1-4

FIG. 6 is a highly schematic cross section of a landfill with a landfill cap.

FIG. 7 is a side elevational view of a first assembly that comprises the double-sided drain liner of FIGS. 1-5.

FIG. 8 is a side elevational view of a second assembly that comprises the double-sided drain liner of FIGS. 1-5.

FIG. 9 is a top plan view of a double-sided drain liner similar to FIG. 5 but with a different arrangement of projections.

FIG. 10 is a side elevational view of a double-sided drain liner similar to FIG. 4, but showing projections having shapes different from the shapes shown in FIG. 4.

FIG. 11 is a side elevational view of a double-sided drain liner similar to FIGS. 4 and 10, but showing projections having shapes different from the shapes shown in FIGS. 4 and 10.

FIG. 12 is a side elevational view of a double-sided drain liner similar to FIGS. 4, 10 and 11, but showing projections having shapes different from the shapes shown in FIGS. 4, 10 and 11.

FIG. 13 is a side elevational view of a double-sided drain liner similar to FIGS. 4 and 10-12, but showing projections having shapes different from the shapes shown in FIGS. 4 and 10-12.

FIG. 14 is a side elevational view of a double-sided drain liner similar to FIG. 4, but showing projections on one side having a shorter projecting height than the projections on the opposite side.

FIG. 15 is a schematic side view of an apparatus for forming the double-sided drain liner.

### DETAILED DESCRIPTION

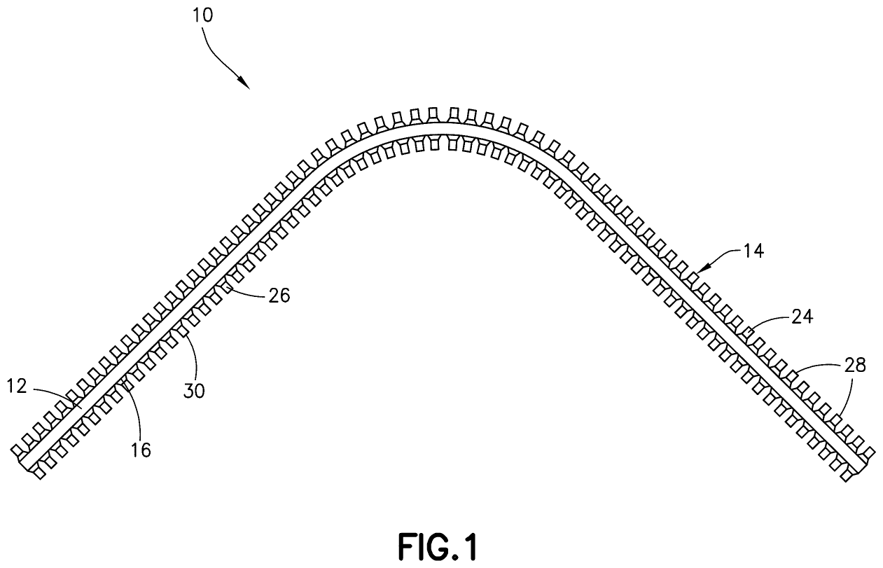

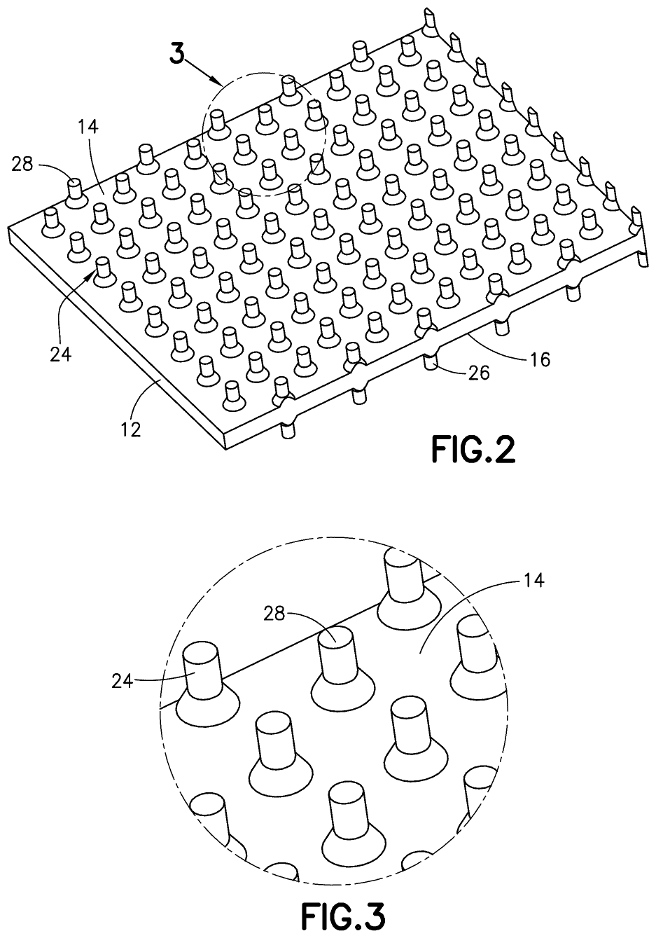

A double-sided drain liner in accordance with an embodiment of the invention is identified generally by the numeral 10 in FIGS. 1-5. The double-sided drain liner 10 in accordance with this embodiment is a unitary or monolithic sheet of extruded polyethylene, polypropylene, polyvinyl chloride or other suitable resin. A width of the double-sided drain liner 10, as measured transverse to an extrusion, may be approximately 6 meters, and a length of the double-sided drain liner 10, as measured along the extrusion direction, can be much longer than the width. The double-sided drain liner 10 has a fluid impervious barrier sheet 12 with opposite upper and lower surfaces 14 and 16 defining a thickness that typically will be in a range of 0.6 mm-2.5 mm.

The fluid impervious barrier sheet 12 is characterized by upper truncated projections 24 projecting up from the upper surface 14 of the fluid impervious barrier sheet 12 and lower truncated projections 26 projecting down from the lower surface 16 of the fluid impervious barrier sheet 12. In the illustrated embodiment, the upper and lower truncated projections 24 and 26 are substantially identical. However, the upper truncated projections 24 need not be identical to the lower truncated projections 26. Additionally, the upper truncated projections 24 need not be identical to one another and the lower truncated projections 26 need not be identical to one another

In the illustrated embodiment, each of the upper truncated projections 24 has a flat projecting end 28 that is aligned substantially parallel to the upper surface 14 of the barrier sheet 12 and each of the lower truncated projections 26 has a flat projecting end 30 that is aligned substantially parallel to the lower surface 16 of the barrier sheet 12. However, the projecting ends 28, 30 need not be perfectly flat and need not be perfectly parallel to the upper and lower surfaces 14 and 16 of the barrier sheet 12. More particularly, the projecting ends 28, 30 can be slightly convex (e.g. rounded), provided that the projecting ends 28, 30 will not penetrate into an adjacent layer or surface. The upper and lower truncated projections 24 and 26 typically will be spaced from one another by a spacing in a range of 6-12 mm. Each of the upper and lower truncated projections 24 and 26 typically will have a projecting dimension from the barrier sheet 12 in a range of 1.5-6.0 mm. The projecting ends 28 and 30 of the respective upper and lower truncated projections 24 and 26 will have a width typically in the range of 2.75-4 mm. A width of each truncated projections 24 and 26 at locations adjacent the barrier sheet 12 is at least equal to the width at the flat projecting ends 28 and 30 and preferably is greater than the width at the projecting ends 28 and 30 to facilitate extrusion and calendering that forms the projections 24, 26. In the illustrated embodiment, each of the truncated projections 24 and 26 has a conically generated base adjacent the barrier sheet 12 and a cylindrical or frustum shaped projecting portion adjacent to the respective projecting end 28, 30. However, the truncated projections 24, 26 need not be of stepped configuration as in the illustrated embodiment and can have the shape of a truncated pyramid rather than a frusto-conical shape, as shown.

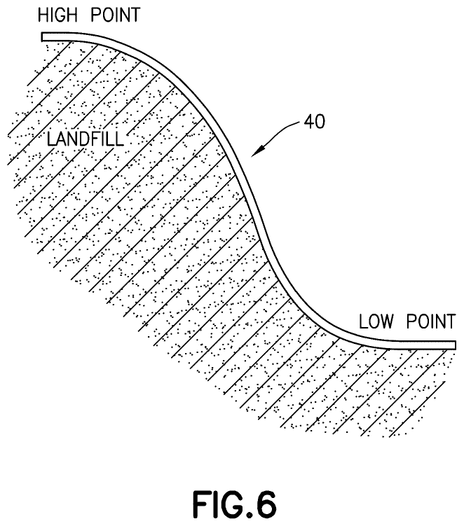

The double-sided drain liner 10 can be used with other sheets or layers to form a landfill cap 40 that covers a landfill, as shown in a highly schematic form in FIG. 6. The landfill of FIG. 6 typically will have a high point, a low point and a slope between the high point and the low point. Some material in the landfill will decay and produce potentially harmful and malodorous methane gas that would escape into the atmosphere absent some form of landfill cap. Trapped methane gas also can combust. Additionally, liquid precipitation can cause material in the landfill to leach into the soil below or laterally adjacent the landfill with potentially catastrophic effect on soil and aquifers. The landfill cap 40 shown schematically in FIG. 6 can control methane gas produced by the landfill and can prevent rainwater from transporting material in the landfill from leaching into soil or aquifers below or adjacent the landfill.

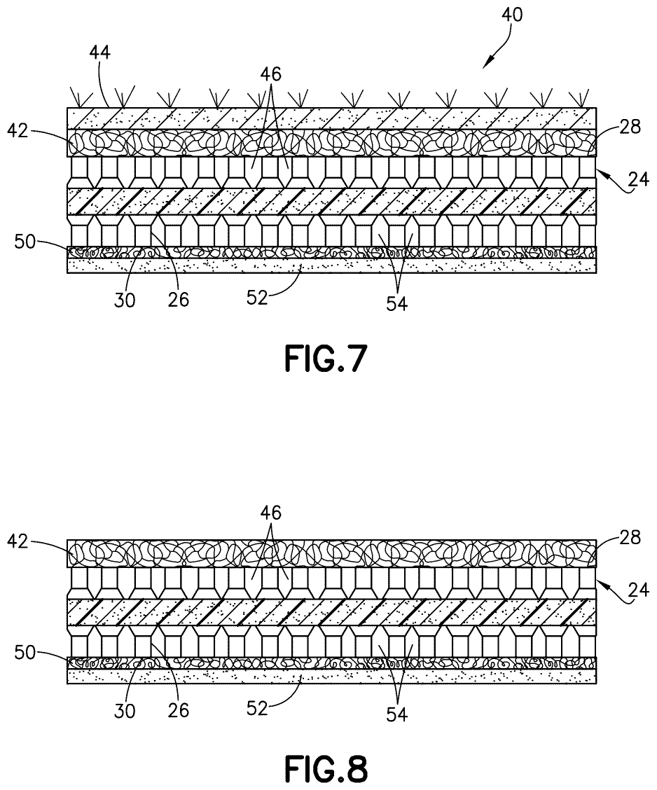

Landfill caps 40 that use the double-sided drain liner 10 are shown, for example, in FIGS. 7 and 8. More particularly, FIG. 7 illustrates an example of a landfill cap 40 that includes the double-sided drain liner 10, a woven or nonwoven drainage or filter layer 42 supported on the projecting ends 28 of the upper truncated projections 24 and a vegetative cover soil 44 supported on the side of the drainage or filter layer 42 opposite the upper truncated projections 24. With this configuration, an array of liquid drainage passages 46 is defined between the upper truncated projections 24 and between the barrier sheet 12 and the drainage or filter layer 42 for accommodating a flow of liquid, such as rain water, to one or more collection points that may be at or near the low point in FIG. 6. Similarly, the landfill cap 40 has the projecting ends 30 of the lower truncated projections 26 supported on a woven or nonwoven gas venting geotextile 50, which in turn is supported on a compacted clay substrate 52 that is on the side of the woven or nonwoven gas venting geotextile 50 that faces away from the double-sided drain liner 10. With this configuration, an array of gas venting passages 54 is defined between the lower truncated projections 26 and between the barrier sheet 12 and the woven or nonwoven gas-venting geotextile 50 for accommodating a flow of methane gas produced by the decaying materials in the landfill. The methane gas will flow generally upward to a collecting station that typically will be at the high point illustrated schematically in FIG. 6.

The FIG. 8 embodiment differs from the FIG. 7 in that the vegetative cover soil 44 is not provided in FIG. 8. FIGS. 7 and 8 differ from the above-described prior art geomembrane systems in that a costly geocomposite layer can be avoided while still ensuring a well-defined array of liquid drainage passages 46 and a separate well-defined array of gas venting passages 54 for respectively accommodating a flow of liquid (e.g. rain water) to an appropriate collection point and a separate flow of methane gas to an appropriate collection point.

The illustrated configurations ensure that liquid, such as liquid generated by rain, will flow through the liquid drainage passages 46 and will be separate from the flow of methane gas through the gas venting passages 54. Thus, the flow of methane gas will not be impeded by an opposite flow of liquid through the liquid draining passages 46 or by liquid that made pool in certain areas.

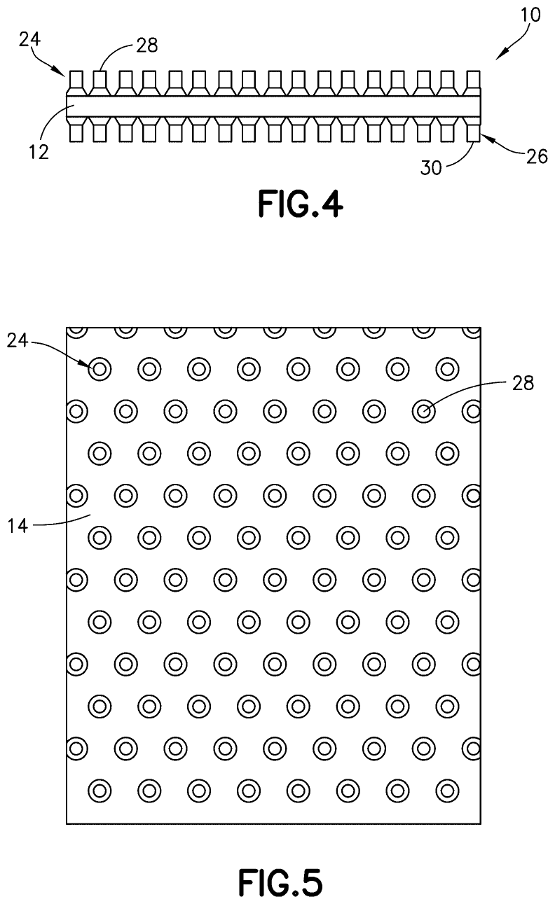

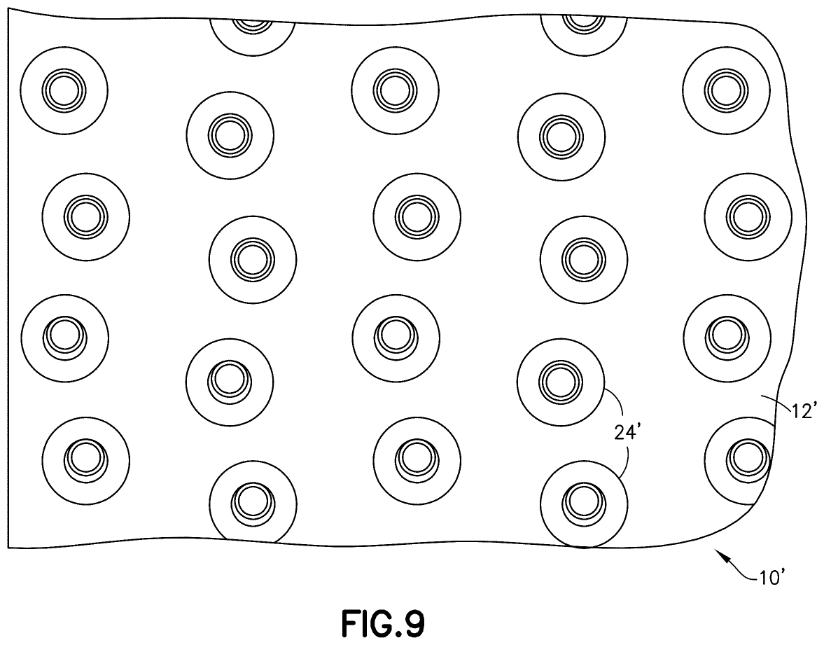

The embodiment of FIGS. 4 and 5 show a double-sided drain liner 10 with projections 24, 26 aligned with one another in rows, but with the projections in each row being offset from the projections in adjacent rows. This arrangement of projections 24 and 26 resists forces exerted on the double-sided drain liner 10 in a direction parallel to the barrier sheet 12 and perpendicular to each row of projections 24, 26. Thus, the projections are less likely to form grooves in an adjacent surface. Such grooves could cause sliding movement of the double-sided drain liner. FIG. 9 is a top plan view of an alternate double-sided drain liner 10′ where the projections 24′ from the barrier sheet 12′ are offset both in the rows and columns for further reducing the possibility of projections forming grooves that extend in any direction in an adjacent surface, and thereby further resisting sliding movement of the double-sided drain liner 10′.

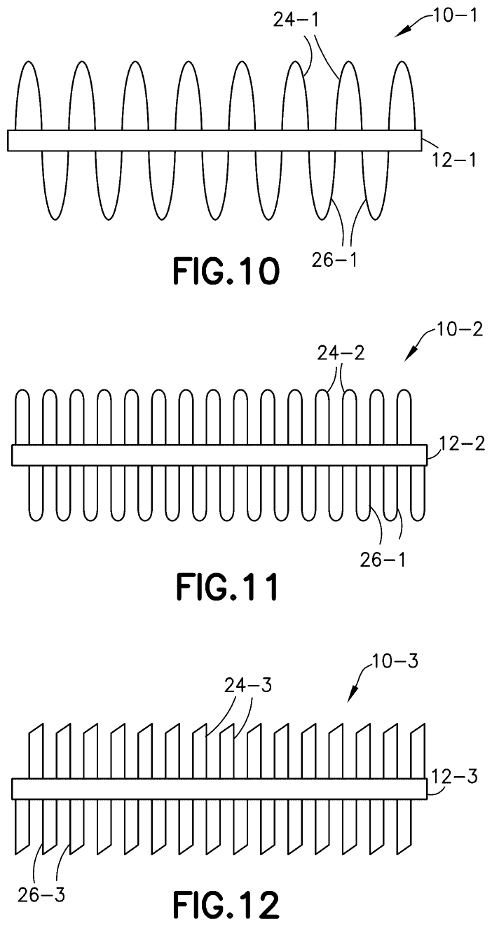

The illustrated configurations show upper and lower truncated projections 24, 26 having side surfaces that are generated symmetrically about a center axis and having projecting ends that are flat and parallel to the barrier sheet 12. However, other optional configurations for the projections 24, 26 are shown in FIGS. 10-14. For example, FIG. 10 shows a double-sided drain liner 10-1 with a barrier sheet 12-1 and projections 24-1, 26-1 that are generated to have substantially ellipsoid shapes. The projecting ends of the projections 24-1, 26-1 are sufficiently blunt to avoid penetrating into an adjacent woven or nonwoven gas venting geotextile. Additionally, the projections 24-1 do not align with the projections 26-1. Rather, the projections 24-1 align with spaces between the projections 26-1. The arrangement of the projections 24-1 and 26-1 still achieves the liquid drainage passages and the gas venting passages. However, the offset disposition of the projections 24-1 relative to the projections 26-1 can facilitate the calendering process and the curing of the resin of the sheet material.

FIG. 11 shows a double-sided drain liner 10-2 with a barrier sheet 12-2 and projections 24-2, 26-2 that are generated to have substantially cylindrical shapes. However, the projecting ends of the projections 24-2, 26-2 have spherically generated ends that are sufficiently blunt to avoid penetrating into an adjacent woven or nonwoven gas venting geotextile. The projections 24-2 do not align with the projections 26-2 as in the previous embodiment.

FIG. 12 shows a double-sided drain liner 10-3 with a barrier sheet 12-3 and projections 24-3, 26-3 that are generated to have substantially cylindrical shapes. However, the projecting ends of the projections 24-3, 26-3 have ends that are substantially planar but not parallel to the plane of the barrier sheet 12-3. Thus, the end of each projection 24-3, 26-3 remote from the barrier sheet 12-3 is somewhat pointed and will bite into an adjacent woven or nonwoven gas venting geotextile to prevent movement between the double-sided drain liner 10-3 parallel to the barrier sheet 12-3 while still maintaining a space between the barrier sheet 12-3 and an adjacent layer. As in the previous embodiments, the double-sided drain liner 10-3 as the projections 24-3 offset from the projections 26-3 and also provides gas venting passages and liquid flow passages on opposite sides of the barrier sheet 12-3 between the projections 24-3 or 26-3.

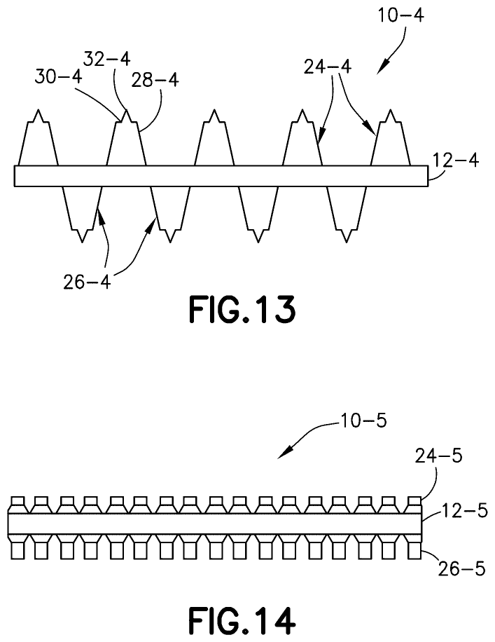

FIG. 13 shows a double-sided drain liner 10-4 with a barrier sheet 12-4 and projections 24-4, 26-4. Each projection 24-4 on the top side of the barrier sheet 12-4 has a conically generated portion 28-4 adjacent the barrier sheet 12-4, a plateau 30-4 facing away from the barrier sheet 12-4 and a point 32-4 remote from the barrier sheet 12-4. The projections 26-4 on the lower side of the barrier sheet 12-4 are shaped similar to the projections 24-4. The points 32-4 will penetrate into an adjacent woven or nonwoven gas venting geotextile to prevent movement between the double-sided drain liner 10-4 and the adjacent woven or nonwoven gas venting geotextile. However, the plateaus 30-4 will limit the amount of penetration into the geotextile, thereby ensuring that gas venting passages and liquid flow passages are provided on opposite sides of the barrier sheet 12-4 and between the respective projections 24-4 and 26-4.

FIG. 14 is a side elevational view of a double-sided drain liner 10-5 similar to FIG. 4 but shows projections 24-5 having a smaller projecting distance than the projections 26-5. This configuration reflects the fact that in some embodiments, a smaller flow space is required for gas venting passages.

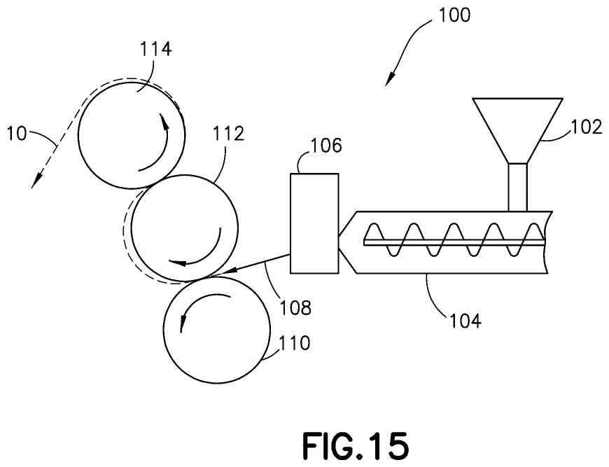

FIG. 15 schematically illustrates an apparatus 100 for forming the double-sided drain liner 10 described herein. The apparatus 100 includes a hopper 102 for receiving the resin that will be processed. An extruding screw 104 receives the resin from the hopper 102. The screw 104 has a helical auger-type rotating member for feeding the resin to an extruder die 106 that feeds a planar sheet into a nip between a bottom embossed roller 110 and a middle embossed roller 112. The embossed rollers 110 and 112 are formed with recesses configured to form the projections 24 and 26 on opposite sides of the extruded sheet. The apparatus 100 further includes a chill roller 114. The double-sided drain liner 10 separates tangentially from the chill roller 114 for further curing of the resin. The double-sided drain liner 10 then is wound onto a roll for shipment to a customer.

1. A double-sided drain liner, comprising: a flexible fluid impervious barrier sheet having opposite first and second surfaces, first truncated projections projecting from the first surface and second truncated projections projecting from the second surface.

2. The double-sided drain liner of claim 1, wherein the barrier sheet and the first and second truncated projections define a monolithic structure formed from a unitary matrix of a synthetic resin.

3. The double-sided drain liner of claim 2, wherein the first and second surfaces of the barrier sheet are substantially parallel, and each of the first and second truncated projections has a blunt surface extending transverse to a projecting direction of the respective projection from the barrier sheet.

4. The double-sided drain liner of claim 2, wherein each of the first and second truncated projections has a blunt non-penetrating end remote from the barrier sheet.

5. The double-sided drain liner of claim 4, wherein the first and second truncated projections have widths measured parallel to the first and second surfaces of the barrier sheet, each of the truncated projections tapering to narrower widths at locations farther from the barrier sheet.

6. The double-sided drain liner of claim 5, wherein the blunt non-penetrating end of each of the first and second truncated projections has a width in a range of 2.75-4 mm.

7. The double-sided drain liner of claim 5, wherein each of the first and second truncated projections has a projecting distance from the barrier layer in a range of 1.5-6.0 mm.

8. The double-sided drain liner of claim 5, wherein the first truncated projections are spaced from one another by a spacing in a range of 6-12 mm and the second truncated projections are spaced from one another by a spacing in a range of 6-12 mm.

9. The double-sided drain liner of claim 4, wherein at least some of the first and second truncated projections have a pointed end surrounded by a blunt non-penetrating shoulder spaced from the barrier sheet.

10. A landfill cap for covering a landfill, the landfill cap comprising:
a gas-venting geotextile for facing the landfill;
a double-sided drain liner having a flexible fluid impervious barrier sheet with a lower surface facing the gas-venting geotextile and an upper surface opposite the lower surface, lower truncated projections projecting from the lower surface of the barrier sheet and having blunt surfaces extending transverse to projecting directions of the lower truncated projections from the barrier sheet, the blunt surfaces being supported in nonpenetrating contact with the gas-venting geotextile so that the barrier layer is spaced from the gas-venting geotextile and so that gas venting passages are defined between the lower truncated projections, upper truncated projections projecting from the upper surface of the barrier sheet and having blunt surfaces extending transverse to projecting directions of the upper truncated projections from the barrier sheet; and
a fluid permeable layer supported in nonpenetrating contact on the blunt surfaces of the upper truncated projections of the double-sided drain liner so that liquid drainage passages are defined between the upper truncated projections.

11. The landfill cap of claim 10, wherein the double-sided drain liner is a monolithic structure extruded from a unitary matrix of a synthetic resin.

12. The landfill cap of claim 11, wherein the upper and lower surfaces of the barrier sheet are substantially parallel, and each of the upper and lower truncated projections has a projecting end that is substantially flat and parallel to the upper and lower surfaces of the barrier sheet.

13. The landfill cap of claim 11, wherein at least some of the upper and lower truncated projections have a point at a projecting end of the respective projection and a shoulder at least partly surrounding the point, the blunt and nonpenetrating surface being formed on the shoulder.

14. A method for controlling gas and liquid flows at a landfill, comprising:
applying a gas-venting geotextile over the landfill;
providing a double-sided drain liner having a flexible fluid impervious barrier sheet with opposite first and second surfaces, first truncated projections projecting from the first surface and second truncated projections projecting from the second surface, the first and second truncated projections having blunt surfaces extending transverse to projecting directions of the first and second truncated directions;
applying the double-sided drain liner on the gas-venting geotextile so that the blunt surfaces of the first truncated projections are supported in nonpenetrating contact on the gas-venting geotextile with the barrier layer spaced from the gas-venting geotextile while forming gas venting passages between the first truncated projections, second truncated projections projecting from the second surface of the barrier sheet; and
applying a fluid permeable layer on the double-sided drain liner so that the fluid permeable layer is supported in nonpenetrating contact on the blunt surfaces of the second truncated projections of the double-sided drain liner with liquid drainage passages being defined between the second truncated projections, wherein gas generated from the landfill flows through the gas venting passages between the first truncated projections to gas collection points and so that liquid precipitation flows through the liquid drainage passages between the second truncated projections to liquid collection points.
